(19) United States
(12) Patent Application Publication
(10) Pub. No.: US 2025/0090880 A1
(43) Pub. Date: Mar. 20, 2025

(54) Fire Extinguishing Apparatus and Methods

(71) Applicants: Gary Johnson, Kirkland, WA (US); Jose Mendoza, Kirkland, WA (US)

(72) Inventors: Gary Johnson, Kirkland, WA (US); Jose Mendoza, Kirkland, WA (US)

(21) Appl. No.: 18/724,190

(22) PCT Filed: Dec. 25, 2021
(86) PCT No.: PCT/US2021/065184

§ 371 Date: Jun. 25, 2024

(51) Int. Cl. A62C 19/00; A62C 3/00; A62C 3/02; A62C 13/78

(52) U.S. Cl. CPC A62C 19/00; A62C 3/006; A62C 3/008; A62C 3/025; A62C 13/78

(57) ABSTRACT

A passive fire extinguisher for indoor and outdoor use. The fire extinguisher comprises a three-dimensional body housing an extinguishing powder, a fuse, and an explosive. The fire extinguisher is removably placed in a fire-risk location and can be paired with additional apparatuses. A fire ignites the extinguisher's fuse, induces combustion, causes the apparatus to open and release the fire extinguishing powder, smothering the fire.

### FIELD OF THE DISCLOSURE

The present disclosure relates to methods and apparatuses for fire extinguishing. More specifically, the present disclosure presents an apparatus comprising a powder extinguishing compound that is released when exposed to fire.

### BACKGROUND OF THE DISCLOSURE

Fires are a threat in nature, in communities, and indoors. Fires are extinguished by starving the flame of oxygen. The flame is smothered. When there is substantial fuel available to support a fire, extinguishing the fire is more difficult. Quick action must be taken to prevent burns, death, damage, and hypoxia.

Traditionally, fires are extinguished by dumping water on the flame. This is not practical because it either requires professional firefighters with a hose connected to a main water source which can cause additional damage, take too long to implement, and is costly. On a smaller scale, water from a bucket can be poured onto a fire in a kitchen for example. Fire blankets are another option for extinguishing fires, but the size of the blanket may be inadequate, and it may not be readily accessible or within quick reach. Pressurized fire extinguishers with a wet or a dry foam are commonly present in homes, commercial spaces, and even in vehicles. These pressurized fire extinguishers are not easy for everyone to use, require training, and require regular maintenance and inspection.

There are also more permanent solutions such as sprinklers. However, installation of sprinklers is expensive, unsightly, and requires connection to a water line.

### SUMMARY OF THE DISCLOSURE

What is needed is are the methods and apparatuses for fire extinguishers that function passively, are low maintenance, are resistant to tampering and the elements, are portable, can be used indoor or outdoor, and are relatively inexpensive.

In one embodiment, the extinguisher has a spherical configuration with a top portion, a bottom portion, a seam that bisects the top portion and the bottom portion, and a top external fastener receiver with a support cable aperture, and a bottom internal cable receiver. A support cable is secured at the internal receiver and threaded through the external receiver at the support cable aperture. A fastener is connected to the support cable for positioning the extinguisher in a hanging configuration on a mount body. Suitable mount bodies include trees and tree branches.

In one embodiment, the extinguisher has a polygonal configuration with magnetic fasteners for positioning the extinguisher in a flush configuration on a mount body where at least one side connects with a mount body via a fastener such as a magnet or adhesive.

The extinguisher has a layered arrangement of a moisture barrier, an ignition line, a heat-transfer barrier, a body exterior surface, a body interior surface, and extinguishing powder and at least one explosive contained within the interior

The extinguisher is used in a unitary configuration or in an array with additional extinguishers in fire-risk locations. Other than periodic inspection for damage, personnel handling, re-loading, and control and operation are unnecessary.

The extinguisher is implemented by placing the extinguisher in either a hanging or a flush configuration on a mount body in a fire-risk area. In the event of a fire, the flame will ignite the ignition line, trigger the fuse, and detonate the explosive, causing the body to burst and release extinguishing powder.

### BRIEF DESCRIPTION OF THE DRAWINGS

The accompanying drawings that are incorporated in and constitute a part of this specification illustrate several embodiments of the disclosure. Together with the description, the figures serve to explain the principles of the disclosure.

FIG. 1 shows a side sagittal view of an exemplary fire extinguishing apparatus in a spherical configuration.

FIG. 2 shows a perspective cross section view of an exemplary fire extinguishing apparatus.

FIG. 3 shows a side sagittal view of an exemplary fire extinguishing apparatus in a polygonal configuration.

FIG. 4 shows a frontal view of an exemplary fire extinguishing apparatus in a spherical configuration extinguishing a fire in an indoor setting.

FIG. 5 shows a perspective view of an exemplary fire extinguishing apparatus in a polygonal configuration placed in a kitchen setting.

FIG. 6 shows a frontal view of an array of exemplary fire extinguishing apparatuses in a forest fire mitigation configuration.

FIG. 7 shows exemplary methods steps for extinguishing a fire with an exemplary fire extinguishing apparatus.

### NUMERALS OF THE FIGURES

1. Extinguisher
3. Body
5. Moisture barrier
7. Ignition line
9. Heat-transfer barrier
11. Fastener
13. Top
15. Top portion
17. Bottom
19. Bottom portion
21. Top seam
23. Bottom seam
25. Exterior surface
27. Interior surface
29. Interior space
31. Air
33. External fastener receiver
35. Support cable aperture
37. Internal support cable receiver
39. Support cable
41. Explosive
43. Explosive fuse
45. Explosive casing
47. Ignition line adhesive
49. Ignition line powder
51. Extinguishing powder
53. Mount body
55. Fire
57. Powder dispersion plume
59. Fire-risk location

### Glossary

“Fastener” as used herein means a device that mechanically attaches—either removably or fixably—two or more objects together. Suitable fastener examples include carabiners, ribbons, twine, loops, hook-and-loop closures, ties, buttons, snaps, wires, cables, magnets, adhesives, glues, and tapes.

“Extinguishing powder” as used herein means a powder, dust, sand, clay, silt, foam, pellet, or grain suitable for depriving a flame of oxygen thereby extinguishing a flame. Suitable extinguishing powder examples include sodium bicarbonate, ammonium phosphate, potassium bicarbonate, siliconized sodium bicarbonate, graphene, ceramic, kaolin, polyphosphazene, silicate composites, and tannic acid colloids.

### DETAILED DESCRIPTION

The present disclosure provides generally for methods and apparatuses for fire extinguishers. The fire extinguishers extinguish fires by inducing combustion. The fire extinguisher is placed on a mount body. When a flame is substantial enough to ignite an ignition line, the ignition line will light an internal fuse and explosive within the extinguisher filled with an extinguishing powder. Extinguishing powder is dispersed into the air and falls with gravity to smother the flame. Preferred embodiments include sodium bicarbonate as the extinguishing powder.

The size and capacity of the extinguisher is scalable so long as there is sufficient interior space to contain extinguishing powder, air, an internal support cable receiver, a support cable, an ignition line, and an explosive. The volume of air and extinguishing powder is also scalable consistent with the size of the extinguisher body. Exemplary extinguishers maintain a low weight-to-volume ratio, eliminating the need to place the extinguisher on a stand, bracket, or platform.

The extinguisher may have a spherical or a polygonal structure in preferred embodiments. However, it is also anticipated a packet or sachet configuration may also be implemented for small-scale settings.

In the following sections, detailed descriptions of examples and methods of the disclosure will be given. The descriptions of both preferred and alternative examples are exemplary only. It is understood that to those skilled in the art that variations, modifications, and alterations may be apparent. It is therefore to be understood that the examples do not limit the broadness of the aspects of the underlying disclosure as defined by the claims.

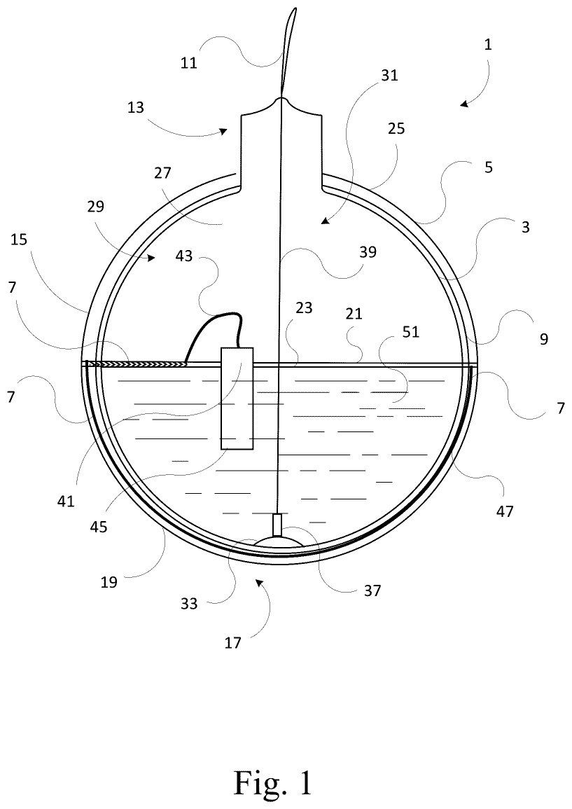

Referring now to FIG. 1, a side sagittal view of an exemplary fire extinguishing apparatus in a spherical configuration is shown. Exemplary fire extinguishers comprise a body, a moisture barrier, an ignition line, a heat-transfer barrier, a fastener, a top portion, a bottom portion, a top seam, a bottom seam, an exterior surface, an interior surface, and an interior space. Within the interior space, there comprises air, an internal support cable receiver, a support cable, an explosive, an explosive fuse, an explosive casing, ignition line adhesive, ignition line powder, and extinguishing powder.

An appreciated benefit of the fire extinguisher is the resistance to tampering and to the elements. Specifically, exemplary fire extinguishers comprise a multi layered stratum which includes an outer-most moisture barrier at the exterior surface and layered on top of a heat-transfer barrier. The heat transfer barrier lies on top of the extinguisher body. The body may be segmented into a top portion and a bottom portion. Between the moisture barrier and the heat-transfer barrier of at least one portion of the body, an ignition line runs along the perimeter of the exterior surface of the body.

In preferred embodiments, the ignition line is not threaded through or contained inside the body interior space. In preferred embodiments, the interior space is not outwardly exposed or ventilated. Rather, the ignition line extends from the perimeter of the exterior surface of the body and onto at least one seam—the bottom seam if extending from the bottom portion or the top seam if extending from the top portion. The ignition line leads to an explosive fuse of an explosive present in the interior space and suspended in a combination of air and extinguishing powder. In some embodiments, the explosive extends across the top seam and the bottom seam and into both the top portion and the bottom portion.

Another appreciated benefit of the fire extinguisher is the low weight-to-size ratio due to optimized configuration of a low-density body layered with a thin moisture barrier and a thin heat-transfer barrier that maintains the integrity of the explosive fuse and ignition line powder without reducing resistance to the elements such as extreme temperatures and moisture. The ignition line may be secured with an adhesive and may comprise a combustible material such as a sulfurous grain or gunpowder.

For example, some extinguishers have a body with a density from about 0.01 to about 0.6 ounces per cubic inch. Exemplary moisture barriers may be a polymer wrap, lacquer, glaze, gel, or sheet material such as cellophane, plastic wrap, or polymer coating. Any substantially impermeable membrane may be a moisture barrier. Exemplary heat barriers may be a glaze, wrap, sheet, gel, or lacquer that may be metallic such as foil sheets.

An appreciated benefit is exemplary extinguishers may be suspended or hung from a branch, ledge, bar, perch, mantle, or hook eliminating the need for the body of the extinguisher to rest or lie on a surface. The extinguisher has an external fastener receiver attached to the bottom portion of the body. The fastener receiver acts as an anchor and is fixably clipped onto or glued onto the body. The external fastener receiver is connected to an internal support cable receiver that is securely attached with glue or solder. The internal support cable receiver has a hollow cylindrical structure capable of clamping or crimping around a support cable. The support cable extends through the interior space, preferably in the center of the interior space, running parallel to the explosive. The support cable extends through the top, ending in a fastener.

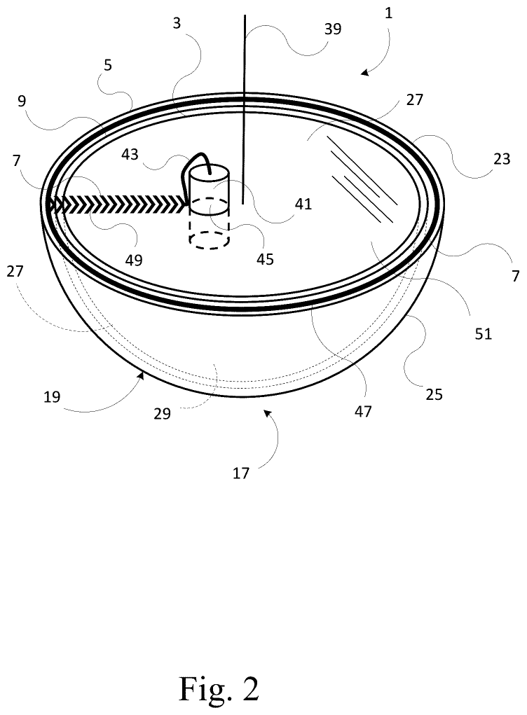

Referring now to FIG. 2, a perspective cross section view of an exemplary fire extinguishing apparatus is shown and includes the same features from FIG. 1. In this particular rendering, the bottom portion of the body and the interior space are shown with the support cable extending upward to the top portion (not shown).

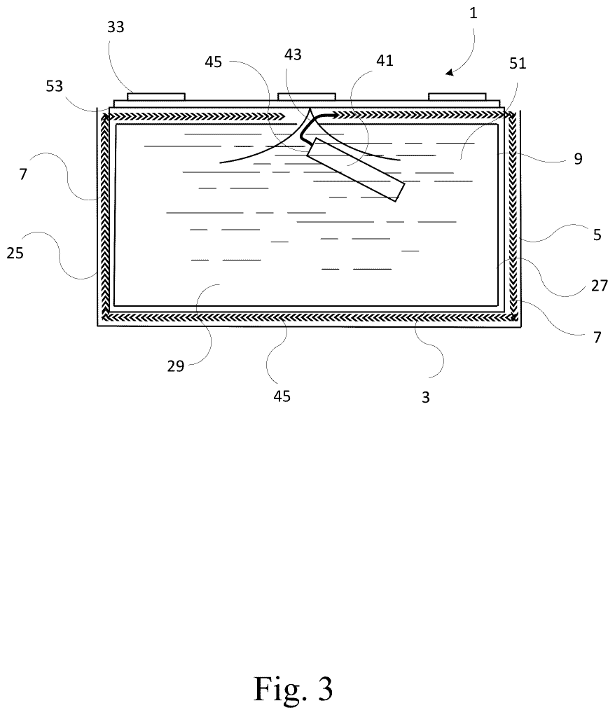

Referring now to FIG. 3, a side sagittal view of an exemplary fire extinguishing apparatus in a polygonal configuration is shown. Polygonal extinguishers have the same layered structure with the body, heat barrier, fuse, and moisture barrier. However, in this particular example, the fastener contains magnets attached to the exterior surface of the extinguisher. This exemplary embodiment is not suspended or intended to hang with the body not contacting a surface. Instead, this extinguisher is designed to have a more seamless aesthetic indoors and used in connection with appliances that may be in a fire-risk location. A mount body is placed against a surface.

The fuse runs along the perimeter of the polygonal shape and ends at an explosive fuse that extends from the fuse and into the body interior space and connects to the explosive. The explosive is suspended in the interior space filled with air and extinguishing powder. The interior space is concealed.

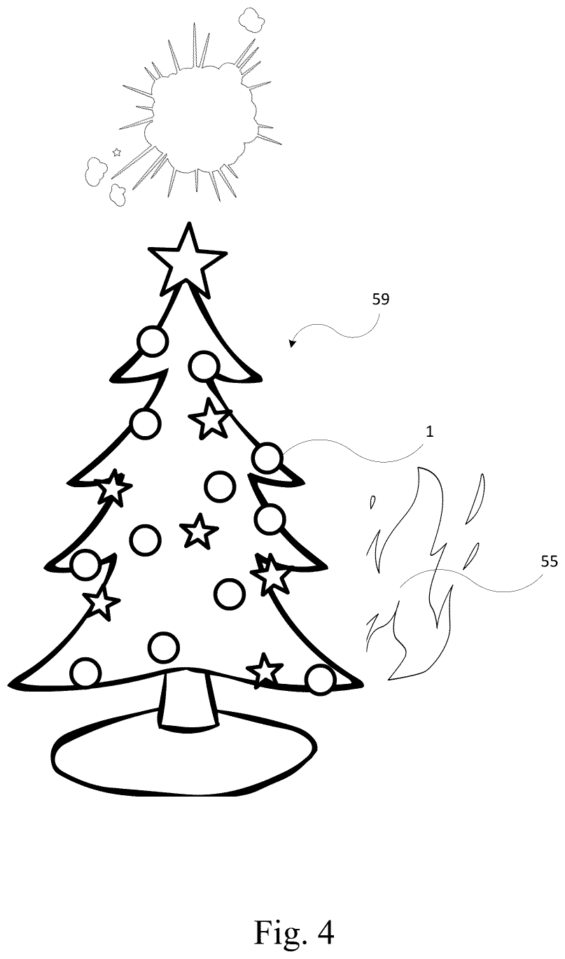

Referring now to FIG. 4, a frontal view of an exemplary fire extinguishing apparatus in a spherical configuration extinguishing a fire in an indoor setting is shown. In preferred embodiments, the extinguisher is placed on branches on a tree such as an indoor or outdoor holiday tree in a fire-risk location. In the even a fire breaks out, the heat from the flame will destroy the moisture barrier, exposing the ignition line to the flame. The ignition line is activated, setting off the fuse, triggering explosion, causing the body to destroy causing a release of extinguishing powder. The extinguishing powder is expelled upward, downward, or sideways, and combinations thereof.

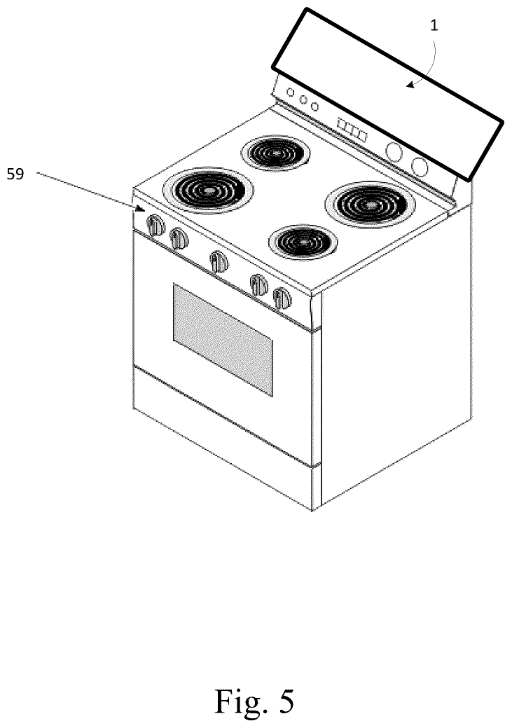

Referring now to FIG. 5, a perspective view of an exemplary fire extinguishing apparatus in a polygonal configuration placed in a kitchen setting is shown. In some embodiments, an extinguisher has a magnet attached to the exterior surface for placement against substantially flat magnetic surfaces in a fire-risk location. Examples include placement on or above kitchen appliances such as stoves, ovens, microwaves, grills, or toasters. Magnetic fire extinguishers of the disclose can also be implemented in outdoor fire-risk areas such as electrical meters and breaker boxes, and lamps.

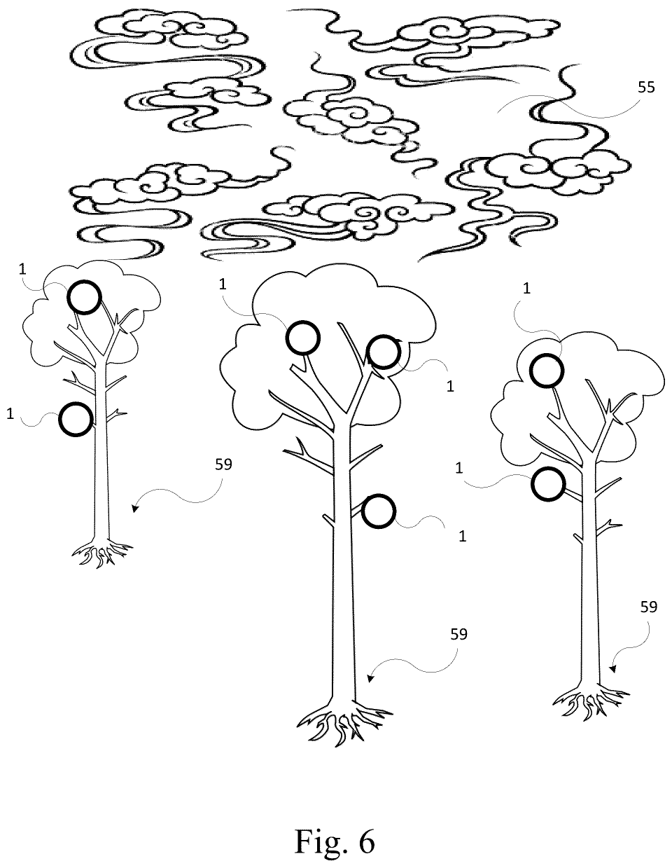

Referring now to FIG. 6, a frontal view of an array of exemplary fire extinguishing apparatuses in a forest fire mitigation configuration is shown. A plurality of fire extinguishers may be fastened or mounted on or around appendages or any surface. The plurality of fire extinguishers may be arranged in a matrix in a defined area. For example, forestry services, parks, and land management entities may place exemplary fire extinguishers in or on trees in a fire-risk location. Doing so may help reduce the spread of forest fires. One or more fire extinguishers may be placed in trees or on or near lodging or campsites. Extinguishers may be hung on branches along various heights of the trees, at least one extinguisher per tree.

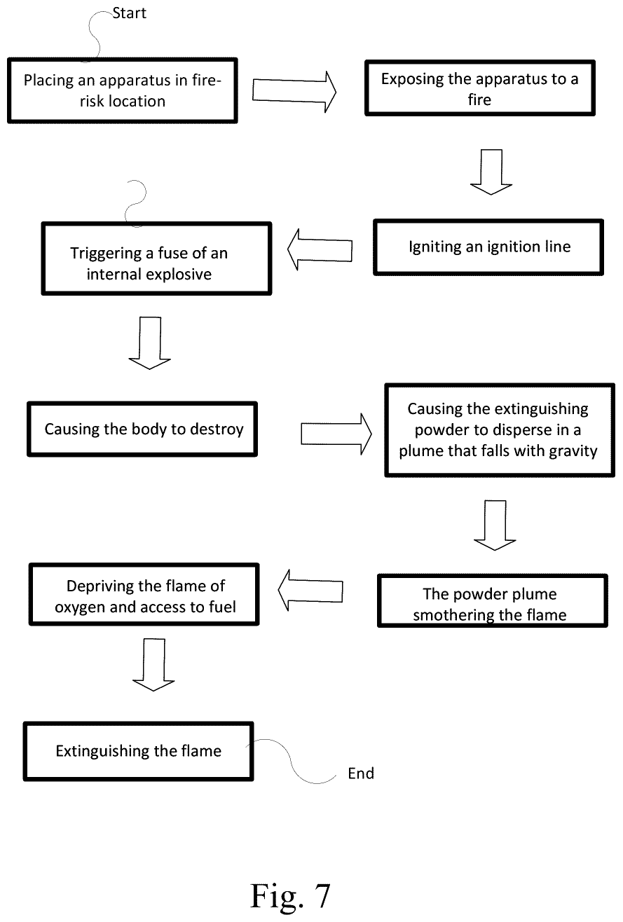

Referring now to FIG. 7, exemplary methods steps for extinguishing a fire with an exemplary fire extinguishing apparatus are shown. Generally, one places an apparatus or extinguisher in a fire-risk location such as an area prone to forest fires, campsites, kitchens, and other indoor and outdoor areas. The extinguisher or apparatus is exposed to a fire where the flame or the heat of the flame ignites an ignition line which triggers a fuse of an explosive present in the interior space of the extinguisher body. The detonation of the explosive causes the body to destroy, burst, or separate. The extinguishing powder in the interior space is dispersed in a plume. The extinguishing powder falls with gravity onto surfaces prone to burning such as trees, furniture, appliances, and décor. The deposition of the powder smothers the flame, depriving the flame of oxygen and access to fuel. Accordingly, the flame is extinguished resulting in limited damage to the surrounding area and minimizing the spread.

### CONCLUSION

A number of embodiments of the present disclosure have been described. While this specification contains many specific implementation details, these should not be construed as limitations on the scope of any disclosures or of what may be claimed. The exemplary embodiments in the detailed description and the figures serve as descriptions of features specific to particular embodiments of the present disclosure.

Certain features that are described in this specification in the context of separate embodiments can also be implemented in combination in a single embodiment. Conversely, various features that are described in the context of a single embodiment can also be implemented in combination in multiple embodiments separately or in any suitable sub-combination. Moreover, although features may be described above as acting in certain combinations and even initially claimed as such, one or more features from a claimed combination can in some cases be excised from the combination, and the claimed combination may be directed to a sub-combination or variation of a sub-combination.

Similarly, while operations or method steps are depicted in the drawings in a particular order, this should not be understood as requiring that such operations be performed in the particular order shown or in sequential order, or that all illustrated operations be performed, to achieve desirable results.

Thus, particular embodiments of the subject matter have been described. Other embodiments are within the scope of the following claims. Nevertheless, it will be understood that various modifications may be made without departing from the spirit and scope of the claimed disclosure.

What is claimed is:

1. A fire extinguisher, comprising:
a. a body having a density of 0.01 to 0.06 ounces per cubic inch, the body defining an interior surface and an exterior surface,
b. a seam that bisects the body into a top portion and a bottom portion,
c. a heat-transfer barrier on top of the exterior surface,
d. a moisture barrier on top of the heat-transfer barrier,
e. an ignition line positioned on top of the heat-transfer barrier and lining a perimeter of a portion of the exterior surface and leading through the seam and into the interior surface and connecting with a fuse of an explosive.

2. The fire extinguisher of claim 1 further comprising a support cable bonded to a support cable receiver.

3. The fire extinguisher of claim 2 wherein the support cable extends from the support cable receiver and through a support cable aperture.

4. The fire extinguisher of claim 3 wherein the support cable extended through the support cable aperture is secured with an external fastener receiver.

5. The fire extinguisher of claim 4 further comprising a fastener connected to the external fastener receiver.

6. The fire extinguisher of claim 1 further comprising a magnet fastener on the exterior surface

7. The fire extinguisher of claim 1 further comprising extinguishing powder.

8. The fire extinguisher of claim 7 wherein the extinguishing powder is selected from a group consisting of sodium bicarbonate, ammonium phosphate, potassium bicarbonate, siliconized sodium bicarbonate, graphene, ceramic, kaolin, polyphosphazene, silicate composites, tannic acid colloids, and combinations thereof.

9. A plurality of fire extinguishers according to claim 5 arranged in a matrix configuration in a defined setting.

10. A plurality of fire extinguishers according to claim 6 arranged in a matrix configuration in a defined setting.

11. The plurality of fire extinguishers of claim 9 or claim 10 wherein the defined setting in is indoor.

12. The plurality of fire extinguishers of claim 9 or claim 10 wherein the defined setting is outdoor.

13. A method of using a fire extinguisher according to claim 7, the method steps comprising
a. obtaining a fire extinguisher,
b. selecting a fastener,
c. attaching the fastener to a fastener receiver, and
d. placing the fire extinguisher in a defined area subject to flames.

14. The method of claim 13 further comprising exposing the fire extinguisher to a flame.

15. The method of claim 13 whereby the fire extinguisher is placed by securing a fastener on, to, or around an appendage or a substantially flat surface.
